(19) United States
(12) Patent Application Publication
(10) Pub. No.: US 2009/0073000 A1
(43) Pub. Date: Mar. 19, 2009

(54) METHOD AND APPARATUS FOR ALERTING ABOUT DRIVING STATE OF VEHICLE

(75) Inventors: Gee Ju CHAE, Daejeon (KR); Seong Ik Cho, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/168,476

(22) Filed: Jul. 7, 2008

(30) Foreign Application Priority Data
Sep. 13, 2007 (KR) 10-2007-0092927

(51) Int. Cl. G08G 1/017

(52) U.S. Cl. 340/937

(57) ABSTRACT

A method and apparatus for alerting a driving state of a vehicle is provided. The method of alerting about a driving state of a vehicle includes: identifying an adjacent vehicle from a photographed image and extracting identification information about the adjacent vehicle; determining whether the adjacent vehicle approaches based on the identification information; and alerting a driver of the vehicle about a hazard due to the adjacent vehicle approaching, when the adjacent vehicle approaches.

### CROSS-REFERENCE TO RELATED APPLICATION

This application claims the benefit of Korean Patent Application No. 10-2007-0092927, filed on Sep. 13, 2007, in the Korean Intellectual Property Office, the entire disclosure of which is incorporated herein by reference.

### BACKGROUND OF THE INVENTION

1. Field of the Invention

The present invention relates to a method and apparatus for alerting a driver of a vehicle about a driving state of the vehicle.

This work was supported by the IT R&D program of MIC/IITA. [2005-S-114-03, Technology Development for Construction and Management of Tangible Content for Telematics Services]

2. Description of Related Art

Generally, a vehicle denotes a transport device that is driven using a motor, without a rail or line. The configuration of the vehicle includes an engine, a fuel supply device, a power delivery device, a suspension, a steering device, a brake, a discharging device, an air conditioner, a cooler, a lubricator, and the like. The vehicle is generally used to transport passengers or freight.

Therefore, when driving the vehicle, the most important things are safe driving and the prevention of a car accident. In order to achieve the above purposes, the vehicle includes various types of auxiliary devices that control the posture of the vehicle, functions of vehicle components, and the like, safety devices such as a safety belt and an airbag, and the like.

In particular, when changing a lane while driving of the vehicle, an accident may occur due to the lack of attention paid to a relative distance and a relative speed of another vehicle that approaches from the rear of the vehicle. Therefore, a driving state alerting apparatus is installed in the vehicle to detect the other vehicle that approaches from the rear of the vehicle and inform a driver of the vehicle that the other vehicle approaches.

Also, the driving state alerting apparatus photographs the other vehicle in an area where observance is impossible via side mirrors, analyzes the photographed vehicle according to an image identification algorithm, and thereby detects the other vehicle. Through this procedure, the driving state alerting apparatus informs the driver of the vehicle about the existence of the other vehicle.

The conventional driving state alerting apparatus includes sensors such as a camera, a radar, and the like, to be capable of detecting an adjacent vehicle. Also, the driving state alerting apparatus uses a scheme of processing information obtained from the sensors, determining the relative distance and the relative speed of the other driving vehicle, and alerting the driver of the vehicle depending on the result of determination. The driving state alerting apparatus also uses a scheme of identifying an adjacent vehicle for each of the front, the rear, and the side using cameras that are installed in the front, the rear, and the side.

However, a method of identifying an adjacent vehicle for each sensor and uniting information obtained from each sensor, or a method of identifying the adjacent vehicle for each camera and alerting a driver of a vehicle requires a great amount of time processing images. Therefore, it may be difficult to provide information in real time. Also, when alerting the driver of the vehicle using an alarm sound, the driver may not hear the alarm sound.

### BRIEF SUMMARY

An aspect of the present invention provides a method and apparatus for alerting a driving state of a vehicle that can analyze an image of an adjacent vehicle, identify the adjacent vehicle in real time, and thereby can more quickly alert a driver of the vehicle about a driving state of the adjacent vehicle.

Another aspect of the present invention also provides a method and apparatus for alerting about a driving state of a vehicle that can identify a side vehicle based on identification (ID) information of a rear vehicle and thereby can more accurately identify another vehicle approaching from the rear and the side of the vehicle.

Another aspect of the present invention also provides a method and apparatus for alerting about a driving state of a vehicle that can provide a driver of the vehicle with more accurate driving state information of a rear vehicle and a side vehicle.

Another aspect of the present invention also provides a method and apparatus for alerting about a driving state of a vehicle that can alert a driver of the vehicle about hazard that may occur due to a rear vehicle and a side vehicle approaching, using various types of media.

Another aspect of the present invention also provides a method and apparatus for alerting about a driving state of a vehicle that enables a driver of the vehicle to recognize an approaching rear vehicle and a side vehicle and thereby drive the vehicle while paying attention to hazards that may occur due to the rear vehicle and the side vehicle approaching.

The present invention is not limited to the above purposes and other purposes not described herein will be apparent to those of skill in the art from the following description.

According to an aspect of the present invention, there is provided a method of alerting about a driving state of a vehicle, the method including: identifying an adjacent vehicle from a photographed image and extracting ID information about the adjacent vehicle; determining whether the adjacent vehicle approaches based on the ID information; and alerting a driver of the vehicle about a hazard due to the adjacent vehicle approaching, when the adjacent vehicle approaches.

In an aspect of the present invention, the photographed image may include at least one of a photographed rear-view image and a photographed side-view image. Also, the identifying and the extracting may include: identifying a rear vehicle using the photographed rear-view image input from a rear-view photographing unit, and extracting ID information about the rear vehicle; and identifying a side vehicle using the photographed side-view image input from a side-view photographing unit, and extracting ID information about the side vehicle.

Also, the extracting of the ID information about the rear vehicle may include identifying from the photographed rear-view image the rear vehicle for each vehicle lane, and extracting, as the ID information, a location of the rear vehicle and information about the rear vehicle. Also, the extracting of the ID information about the side vehicle may include identifying the side vehicle and extracting the ID information about the side vehicle, using information regarding whether the identified side vehicle approaches from a left side or a right side of the vehicle.

Also, the extracting may include extracting, as the ID information, a relative distance and a relative speed of the adjacent vehicle.

Also, the determining may include: computing an idle running distance in braking and a braking distance according to a relative speed of the adjacent vehicle; comparing an addition of the computed idle running distance in braking and the braking distance with a relative distance of the adjacent vehicle; and determining whether the adjacent vehicle is approaching at a speed greater than the relative speed within the relative distance when the addition is greater than the relative distance.

Also, the method may further include: periodically identifying a location of the adjacent vehicle; and displaying a driving state of the adjacent vehicle on a screen based on the location.

Also, the alerting may include at least one of: outputting an alarm sound using a sound output unit; and vibrating a handle or a seat to alert the driver of the vehicle using a haptic unit.

According to another aspect of the present invention, there is provided an apparatus for alerting about a driving state of a vehicle, the apparatus including: an identification unit to identify an adjacent vehicle from a photographed image; an extraction unit to extract ID information about the adjacent vehicle; a determination unit to determine whether the adjacent vehicle approaches based on the ID information; and an alerting unit to alert a driver of the vehicle about a hazard due to the adjacent vehicle approaching, when the adjacent vehicle approaches.

In an aspect of the present invention, the photographed image may include at least one of a photographed rear-view image and a photographed side-view image. The extraction unit may extract ID information about a rear vehicle using the photographed rear-view image input from a rear-view photographing unit. Also, the extraction unit may extract ID information about a side vehicle using the photographed side-view image input from a side-view photographing unit.

Also, the extraction unit may identify from the rear-view photographed image the rear vehicle for each vehicle lane and extract, as the ID information, a location of the rear vehicle and information about the rear vehicle. Also, the extraction unit may identify the side vehicle and extract the ID information about the side vehicle, based on information regarding whether the identified side vehicle approaches from a left side or a right side of the vehicle.

Also, the extraction unit may extract, as the ID information, a relative distance and a relative speed of the adjacent vehicle.

Also, the determination unit may compute an idle running distance in braking and a braking distance according to a relative speed of the adjacent vehicle, compare an addition of the computed idle running distance in braking and the braking distance with a relative distance of the adjacent vehicle, and determine the adjacent vehicle is approaching at a speed of greater than the relative speed within the relative distance when the addition is greater than the relative distance.

Also, the apparatus may further include a display unit to periodically identify a location of the adjacent vehicle and display a driving state of the adjacent vehicle on a screen based on the location.

Also, the alerting unit may output an alarm sound using a sound output unit, or vibrate a handle or a seat to alert the driver of the vehicle using a haptic unit.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of alerting about a driving state of a vehicle according to an exemplary embodiment of the present invention;

FIG. 2 illustrates an example of displaying a driving state of a rear vehicle on a screen according to an exemplary embodiment of the present invention; and

FIG. 3 is a block diagram illustrating an apparatus for alerting about a driving state of a vehicle according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below in order to explain the present invention by referring to the figures.

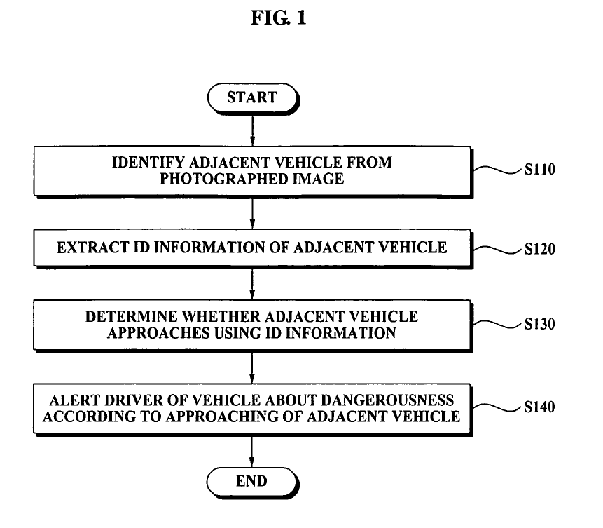

FIG. 1 is a flowchart illustrating a method of alerting a driving state of a vehicle according to an exemplary embodiment of the present invention. The method of alerting the driving state of the vehicle may be configured in a driving state alerting apparatus installed in the vehicle.

Referring to FIG. 1, in operation S110, the driving state alerting apparatus may identify an adjacent vehicle from a photographed image. The photographed image may include at least one of a photographed rear-view image, and a photographed left-view/right-view image.

Specifically, the driving state alerting apparatus may identify a rear vehicle using the photographed rear-view image input from a rear-view photographing unit, and identify a side vehicle using a photographed side-view image input from a side-view photographing unit.

The driving state alerting apparatus may determine whether the rear vehicle is the same as the side vehicle based on a location of the rear vehicle, information about the rear vehicle, a location of the side vehicle, and information about the side vehicle.

Specifically, the driving state alerting apparatus may extract information about the rear vehicle from the photographed rear-view image and extract information about the side vehicle from the photographed side-view image. When the extracted rear vehicle information is identical to the extracted side vehicle information, the driving state alerting apparatus may determine the side vehicle and the rear vehicle are the same vehicle.

The rear vehicle information may include the color of the rear vehicle, the size of the rear vehicle, the aspect ratio of the rear vehicle, and the like. The driving state alerting apparatus may inspect a color distribution regarding an identified vehicle region in the photographed rear-view or side-view image, and extract the color of the vehicle. Also, the driving state alerting apparatus may detect the location of the vehicle and compute the size and the aspect ratio of the vehicle based on the detected location.

The rear-view photographing unit may interoperate with the side-view photographing unit. The rear-view photographing unit may be installed in the rear of the vehicle and also may include at least one photographing unit. The rear-view photographing unit may photograph the rear-view of the vehicle and thereby generate a moving picture of the rear view. The rear-view photographing unit may randomly extract a frame from the moving picture and thereby output the photographed rear-view image. Therefore, the driving state alerting apparatus may receive the photographed rear-view image and identify the rear vehicle from the received photographed rear-view image.

When at least two rear-view photographing units are installed in the rear of the vehicle, the photographed rear-view image may include information that is used to identify from which rear-view photographing unit the photographed rear-view image is received.

The side-view photographing unit may include a left side-view photographing unit and a right side-view photographing unit. The left side-view photographing unit may be installed in the left of the vehicle and also may include at least one photographing unit. The left side-view photographing unit may photograph a left side-view of the vehicle and generate a moving picture of the left side-view. The left side-view photographing unit may randomly extract a frame from the moving picture and output a photographed left side-view image. Therefore, the driving state alerting apparatus may receive the photographed left side-view image and identify the left vehicle from the received photographed left side-view image.

The right side-view photographing unit may be installed in the right of the vehicle and include at least one photographing unit. The right side-view photographing unit may photograph a right side-view of the vehicle and generate a moving picture of the right side-view. Also, the right side-view photographing unit may randomly extract a frame of the moving picture and output a photographed right side-view image. Therefore, the driving state alerting apparatus may receive the photographed right side-view image and identify the right vehicle from the received photographed right side-view image.

Hereinafter, an example of a process of identifying the rear vehicle by the driving state alerting apparatus will be described. The driving state alerting apparatus may determine the lane marker, extract a lane marker from the photographed rear-view image, trace a corresponding lane, predict the shape of the lane, and thereby identify the corresponding lane. In order to prevent erroneous identification due to the lane, the driving state alerting apparatus may remove the lane marker from the identified lane, detect a vehicle search region, and extract candidate vehicles through a region division based on length edge information, a region unification using a class deviation, and determination of a vehicle region. The driving state alerting apparatus may identify a corresponding vehicle from the candidate vehicles based on a reliability evaluation.

When the left vehicle is identical to the right vehicle, the driving state alerting apparatus may use the same algorithm. This is because the left side of the vehicle is symmetric to the right side of the vehicle.

As described above, the driving state alerting apparatus may identify the side vehicle based on identification (ID) information of the rear vehicle and thereby more accurately identify another vehicle that approaches from the rear and the side of the vehicle. Through this, the driving state alerting apparatus may provide the driver of the vehicle with more accurate driving state information of the rear vehicle and the side vehicle.

In operation S120, the driving state alerting apparatus may extract ID information about the adjacent vehicle.

Specifically, the driving state alerting apparatus may identify the rear vehicle using the photographed rear-view image input from the rear-view photographing unit and extract ID information about the rear vehicle. For this, the driving state alerting apparatus may identify from the photographed rear-view image a rear vehicle for each lane and extract, as the ID information, a location of the rear vehicle and rear vehicle information.

Also, the driving state alerting apparatus may identify the side vehicle using the photographed side-view image input from the side-view photographing unit, and extract ID information about the side vehicle. For this, the driving state alerting apparatus may identify the side vehicle and extract ID information about the side vehicle, based on whether the identified rear vehicle approaches from the left side or the right side of the vehicle.

When the other vehicle is approaching from the left side or the right side of the vehicle, the driving state alerting apparatus may track an identification target for each of the left side and the right side and extract ID information. Conversely, when the other vehicle is not approaching, the driving state alerting apparatus may recognize the other vehicle using a side-view identification algorithm. The side-view identification algorithm is a disclosed technology and thus descriptions related thereto will be omitted here.

Hereinafter, an example of a process of identifying the side vehicle by the driving state alerting apparatus will be described. Specifically, the driving state alerting apparatus may extract from the photographed side-view image candidate regions using vertical and horizontal edge detection and also extract candidate vehicles through comparison of candidate regions using a previous frame. The driving state alerting apparatus may identify a corresponding vehicle from the candidate vehicles based on a reliability evaluation.

When the other vehicle is approaching from the left side or the right side of the vehicle, the driving state alerting apparatus may track an identification target based on ID information of the rear vehicle, such as the color, the size, the distance, and the like, and extract the ID information. Conversely, when the other vehicle is not approaching, the driving state alerting apparatus may identify the side vehicle based on a process of identifying the side vehicle.

The driving state alerting apparatus may detect, as the ID information, a relative distance and a relative speed of the adjacent vehicle. For this, the driving state alerting apparatus may obtain information regarding the height of the rear-view/side-view photographing unit, a focal distance of the rear-view/side-view photographing unit, a coordinate value of the adjacent vehicle in the photographed rear-view/side-view image, and the like. The adjacent vehicle may include the rear vehicle and the side vehicle.

Specifically, the driving state alerting apparatus may detect the relative distance and the relative speed of the rear vehicle based on the obtained information. The rear vehicle may include the left-side vehicle or the right-side vehicle that is determined to be the same vehicle as the rear vehicle.

Therefore, the driving state alerting apparatus may more accurately detect the relative distance and the relative speed of the adjacent vehicle. Through this, it is possible to more accurately determine an alert condition.

Also, the driving state alerting apparatus may detect only the relative distance of the identified rear vehicle. Specifically, the driving state alerting apparatus may obtain information regarding the height of the rear-view/side-view photographing unit, a focal distance of the rear-view/side-view photographing unit, a coordinate value of the adjacent vehicle in the photographed rear-view/side-view image, and the like. The driving state alerting apparatus may detect the relative distance of the adjacent vehicle based on the obtained information.

Also, the driving state alerting apparatus may identify each lane from the photographed rear-view image, and extract, as the ID information, a location of a rear vehicle for each lane, and rear vehicle information.

In operation S130, the driving state alerting apparatus may determine whether the adjacent vehicle approaches based on the ID information. Specifically, the driving state alerting apparatus may compute an idle running distance in braking and a braking distance according to a relative speed of the adjacent vehicle, and compare an addition of the computed idle running distance in braking and the braking distance with a relative distance with the adjacent vehicle. When the addition is greater than the relative distance, the driving state alerting apparatus may determine the adjacent vehicle is approaching at a speed greater than the relative speed within the relative distance.

For example, when it is assumed that the idle running distance in braking is 30 m, the braking distance is 5 m, and the relative distance is 20 m, the addition of the idle running distance in braking and the braking distance is 35 m greater than the relative distance of 20 m. Therefore, the driving state alerting apparatus may determine a hazardous situation may occur due to the rear vehicle approaching. Specifically, when a difference between the addition of the idle running distance in braking and the braking distance, and the relative distance exceeds a predetermined threshold, the driving state alerting apparatus may determine an alert condition, that is, a hazard according to the relative distance and the relative speed is satisfied.

Also, the driving state alerting apparatus may determine whether the rear vehicle is approaching from the left side or the right side of the vehicle, based on the location of the rear vehicle for each lane and rear vehicle information.

Accordingly, the driving state alerting apparatus may more accurately determine the hazard due to the rear vehicle and the side vehicle approaching.

The idle running distance in braking denotes a distance that is traversed until the vehicle is actually stopped by braking since the driver discovers a hazard in driving the vehicle and brakes. The idle running distance in braking is computed by multiplying the speed of the vehicle and an idle running time, that is, a reaction time. The braking distance denotes a distance that is traversed until the vehicle is completely stopped from when the brake of the vehicle being driven is applied.

The driving state alerting apparatus may determine whether the rear vehicle is approaching based on only the detected relative distance. Specifically, when the relative distance is less than a predetermined distance, the driving state alerting apparatus may determine the rear vehicle is approaching. Conversely, when the relative distance is greater than the distance, the driving state alerting apparatus may determine the rear vehicle is not approaching.

In operation S140, when the adjacent vehicle approaches, the driving state alerting apparatus may alert the driver of the vehicle about the hazard due to the adjacent vehicle approaching. Specifically, when the alert condition is satisfied, the driving state alerting apparatus may alert the driver of the vehicle. The alert condition may include a case where the adjacent vehicle is approaching at a speed greater than the relative speed within the distance, a case where the adjacent vehicle is approaching within the relative distance, and the like.

The driving state alerting apparatus may output an alarm sound using a sound output unit such as a speaker. Also, the driving state alerting apparatus may vibrate a handle or a seat to alert the driver of the vehicle using a haptic unit.

Accordingly, the driving state alerting apparatus may alert the driver of the vehicle about the hazard due to the adjacent vehicle approaching. Through this, the driving state alerting apparatus may enable the driver of the vehicle to be aware of the adjacent vehicle approaching and drive the vehicle while paying attention to the adjacent vehicle.

Also, the driving state alerting apparatus may display a driving state of the adjacent vehicle on a screen of a terminal. For this, the driving state alerting apparatus may periodically detect the location of the adjacent vehicle. Specifically, the driving state alerting apparatus may display the driving state of the adjacent vehicle on the screen based on the detected location.

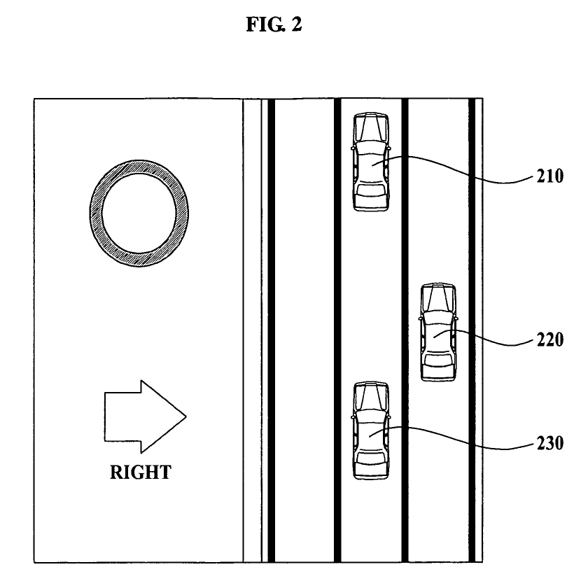

FIG. 2 illustrates an example of displaying a driving state of a rear vehicle on a screen according to an exemplary embodiment of the present invention.

As shown in FIG. 2, the driving state alerting apparatus may periodically detect a location of a vehicle 210 driven by a user and locations of rear vehicles 220 and 230, and display the driving state of the vehicle 210, and the driving state of the rear vehicles 220 and 230 based on the detected locations. On the screen of FIG. 2, the rear vehicle 220 is being driven in a lane to the right of the vehicle 210 and the rear vehicle 230 is being driven in a lane to the left of the vehicle 210.

When displaying on the screen a location of a left-side vehicle, a location of a right-side vehicle, and a location of a rear vehicle based on a location of a vehicle being driven by a user, the rear vehicle may be overlapped with the left-side vehicle and the right-side vehicle. In this case, the driving state alerting apparatus may give priority to and display the rear vehicle.

The driving state alerting method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

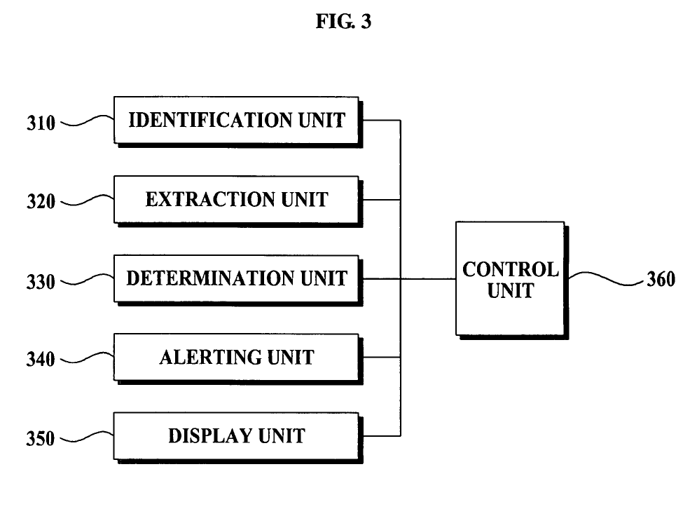

FIG. 3 is a block diagram illustrating an apparatus for alerting a driving state of a vehicle according to an exemplary embodiment of the present invention.

Referring to FIG. 3, the driving state alerting apparatus may include an identification unit 310, an extraction unit 320, a determination unit 330, an alerting unit 340, a display unit 350, and a control unit 360.

The identification unit 310 may identify an adjacent vehicle from a photographed image. The photographed image may include at least one of a photographed rear-view image, a photographed left-view/right-view image, and the like.

Specifically, the identification unit 310 may identify a rear vehicle using the photographed rear-view image input from a rear-view photographing unit, and identify a side vehicle using a photographed side-view image input from a side-view photographing unit.

The identification unit 310 may determine whether the rear vehicle the same as the side vehicle based on a location of the rear vehicle, information about the rear vehicle, a location of the side vehicle, and information about the side vehicle.

Specifically, the identification unit 310 may extract information about the rear vehicle from the photographed rear-view image and extract information about the side vehicle from the photographed side-view image. When the extracted rear vehicle information is identical to the extracted side vehicle information, the identification unit 310 may determine the side vehicle and the rear vehicle are the same vehicle.

The rear vehicle information may include the color of the rear vehicle, the size of the rear vehicle, the aspect ratio of the rear vehicle, and the like. The identification unit 310 may inspect a color distribution regarding an identified vehicle region in the photographed rear-view or side-view image and extract the color of the vehicle. Also, the identification unit 310 may detect the location of the vehicle and compute the size and the aspect ratio of the vehicle based on the detected location.

The rear-view photographing unit may interoperate with the side-view photographing unit. The rear-view photographing unit may be installed in the rear of the vehicle and also may include at least one photographing unit. The rear-view photographing unit may photograph the rear-view of the vehicle and thereby generate a moving picture of the rear view. The rear-view photographing unit may randomly extract a frame from the moving picture and thereby output the photographed rear-view image. Therefore, the identification unit 310 may receive the photographed rear-view image and identify the rear vehicle from the received photographed rear-view image.

When at least two rear-view photographing units are installed in the rear of the vehicle, the photographed rear-view image may include information that is used to identify from which rear-view photographing unit the photographed rear-view image is received.

The side-view photographing unit may include a left side-view photographing unit and a right side-view photographing unit. The left side-view photographing unit may be installed in the left of the vehicle and also may include at least one photographing unit. The left side-view photographing unit may photograph a left side-view of the vehicle and generate a moving picture of the left side-view. The left side-view photographing unit may randomly extract a frame from the moving picture and output a photographed left side-view image. Therefore, the identification unit 310 may receive the photographed left-view image and identify the left vehicle from the received photographed left side-view image.

The right side-view photographing unit may be installed in the right of the vehicle and include at least one photographing unit. The right side-view photographing unit may photograph a right side-view of the vehicle and generate a moving picture of the right side-view. Also, the right side-view photographing unit may randomly extract a frame of the moving picture and output a photographed right side-view image. Therefore, the identification unit 310 may receive the photographed right-view image and recognize the right vehicle from the received photographed right side-view image.

Hereinafter, an example of a process of recognizing the rear vehicle by the identification unit 310 will be described. The identification unit 310 may determine the lane marker, extract a lane marker from the photographed rear-view image, trace a corresponding lane, predict the shape of the lane, and thereby identify the corresponding lane. In order to prevent erroneous identification due to the lane, the identification unit 310 may remove the lane marker from the identified lane, detect a vehicle search region, and extract candidate vehicles through a region division based on length edge information, a region unification using a class deviation, and determination of a vehicle region. The identification unit 310 may identify a corresponding vehicle from the candidate vehicles based on a reliability evaluation.

When the left vehicle is identical to the right vehicle, the identification unit 310 may use the same algorithm. This is because the left side of the vehicle is symmetric to the right side of the vehicle.

As described above, the identification unit 310 may identify the side vehicle based on ID information of the rear vehicle and thereby more accurately identify another vehicle that approaches from the rear and the side of the vehicle. Through this, the identification unit 310 may provide the driver of the vehicle with more accurate driving state information of the rear vehicle and the side vehicle.

The extraction unit 320 may extract ID information about the adjacent vehicle.

Specifically, the extraction unit 320 may extract ID information about the rear vehicle using the photographed rear-view image input from the rear-view photographing unit. For this, the extraction unit 320 may identify from the photographed rear-view image a rear vehicle for each lane and extract, as the ID information, a location of the rear vehicle and rear vehicle information.

Also, the extraction unit 320 may extract ID information about the side vehicle using the photographed side-view image input from the side-view photographing unit. For this, the extraction unit 320 may identify the side vehicle and extract the ID information about the side vehicle, based on whether the identified rear vehicle approaches from the left-side or the right side of the vehicle.

When the other vehicle is approaching from the left side or the right side of the vehicle, the extraction unit 320 may track an identification target for each of the left side and the right side and extract ID information. Conversely, when the other vehicle is not approaching, the extraction unit 320 may recognize the other vehicle using a side-view identification algorithm. The side-view identification algorithm is a disclosed technology and thus descriptions related thereto will be omitted here.

Hereinafter, an example of a process of identifying the side vehicle will be described. Specifically, the extraction unit 320 may extract from the photographed side-view image candidate regions using vertical and horizontal edge detection and also extract candidate vehicles through comparison of candidate regions using a previous frame. The extraction unit 320 may identify a corresponding vehicle from the detected candidate vehicles based on a reliability evaluation.

When the other vehicle is approaching from the left side or the right side of the vehicle, the extraction unit 320 may track an identification target based on ID information of the rear vehicle, such as the color, the size, the distance, and the like, and extract the ID information. Conversely, when the other vehicle is not approaching, the extraction unit 320 may identify the side vehicle based on a process of identifying the side vehicle.

The extraction unit 320 may detect, as the ID information, a relative distance and a relative speed of the adjacent vehicle. For this, the extraction unit 320 may obtain information regarding the height of the rear-view/side-view photographing unit, a focal distance of the rear-view/side-view photographing unit, a coordinate value of the adjacent vehicle in the photographed rear-view/side-view image, and the like.

Specifically, the extraction unit 320 may detect the relative distance and the relative speed of the rear vehicle based on the obtained information. The rear vehicle may include the left-side vehicle or the right-side vehicle that is determined to be the same vehicle as the rear vehicle.

Therefore, the extraction unit 320 may more accurately detect the relative distance and the relative speed of the adjacent vehicle. Through this, it is possible to more accurately determine an alert condition.

Also, the extraction unit 320 may detect only the relative distance of the identified rear vehicle. Specifically, the extraction unit 320 may obtain information regarding the height of the rear-view/side-view photographing unit, a focal distance of the rear-view/side-view photographing unit, a coordinate value of the adjacent vehicle in the photographed rear-view/side-view image, and the like. The extraction unit 320 may detect the relative distance of the adjacent vehicle based on the obtained information.

Also, the extraction unit 320 may identify each lane from the photographed rear-view image, and extract, as the ID information, a location of a rear vehicle for each lane, and rear vehicle information.

The determination unit 330 may determine whether the adjacent vehicle approaches based on the ID information. Specifically, the determination unit 330 may compute an idle running distance in braking and a braking distance according to a relative speed with the adjacent vehicle, and compare an addition of the computed idle running distance in braking and the braking distance with a relative distance of the adjacent vehicle. When the addition is greater than the relative distance, the determination unit 330 may determine the adjacent vehicle is approaching at a speed greater than the relative speed within the relative distance.

Also, the determination unit 330 may determine whether the rear vehicle is approaching from the left side or the right side of the vehicle, based on the location of the rear vehicle for each lane and rear vehicle information.

Accordingly, the determination unit 330 may more accurately determine the hazard due to the rear vehicle and the side vehicle approaching.

The determination unit 330 may determine whether the rear vehicle is approaching based on only the detected relative distance. Specifically, when the relative distance is less than a predetermined distance, the determination unit 330 may determine the rear vehicle is approaching. Conversely, when the relative distance is greater than the distance, the determination unit 330 may determine the rear vehicle is not approaching.

When the adjacent vehicle approaches, the alerting unit 340 may alert the driver of the vehicle about the hazard due to the adjacent vehicle approaching. Specifically, when the alert condition is satisfied, the alerting unit 340 may alert the driver of the vehicle. The alert condition may include a case where the adjacent vehicle is approaching at a speed greater than the relative speed within the distance, a case where the adjacent vehicle is approaching within the relative distance, and the like.

The alerting unit 340 may output an alarm sound using a sound output unit such as a speaker. Also, the alerting unit 340 may vibrate a handle or a seat to alert the driver of the vehicle using a haptic unit.

Accordingly, the alerting unit 340 may alert the driver of the vehicle about the hazard due to the adjacent vehicle approaching. Through this, alerting unit 340 may enable the driver of the vehicle to be aware of the adjacent vehicle approaching and drive the vehicle while paying attention to the adjacent vehicle.

The display unit 350 may display a driving state of the adjacent vehicle on a screen of a terminal. For this, the display unit 350 may periodically detect the location of the adjacent vehicle. Specifically, the display unit 350 may display the driving state of the adjacent vehicle on the screen based on the detected location.

When displaying on the screen a location of a left-side vehicle, a location of a right-side vehicle, and a location of a rear vehicle based on a location of a vehicle being driven by a user, the rear vehicle may be overlapped with the left-side vehicle and the right-side vehicle. In this case, the display unit 350 may give priority to and display the rear vehicle.

Accordingly, the display unit 350 may display the driving state of the rear vehicle for the driver of the vehicle. Through this, the display unit 350 may enable the driver of the vehicle to drive the vehicle while paying attention to the driving state of the adjacent vehicle.

The control unit 360 functions to control the driving state alerting apparatus. Specifically, the control unit 360 may transfer control signals to the identification unit 310, the extraction unit 320, the determination unit 330, the alerting unit 340, and the display unit 350, respectively and thereby control operations thereof.

According to the present invention, it is possible to analyze an image of an adjacent vehicle, identify the adjacent vehicle in real time, and thereby more quickly alert a driver of the vehicle about a driving state of the adjacent vehicle.

Also, according to the present invention, it is possible to identify a side vehicle based on ID information of a rear vehicle and thereby more accurately identify another vehicle approaching from the rear and the side of the vehicle.

Also, according to the present invention, it is possible to provide a driver of a vehicle with more accurate driving state information of a rear vehicle and a side vehicle.

Also, according to the present invention, it is possible to alert a driver of a vehicle about a hazard that may occur due to a rear vehicle and a side vehicle approaching, using various types of media.

Also, according to the present invention, it is possible to enable a driver of a vehicle to recognize a rear vehicle and a side vehicle approaching and thereby drive the vehicle while paying attention to a hazard that may occur due to the rear vehicle and the side vehicle approaching.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of alerting about a driving state of a vehicle, the method comprising:
identifying an adjacent vehicle from a photographed image and extracting identification information about the adjacent vehicle;
determining whether the adjacent vehicle approaches based on the identification information; and
alerting a driver of the vehicle about a hazard due to the adjacent vehicle approaching, when the adjacent vehicle approaches.

2. The method of claim 1, wherein the photographed image includes at least one of a photographed rear-view image and a photographed side-view image, and
the identifying and the extracting comprises:
identifying a rear vehicle using the photographed rear-view image input from a rear-view photographing unit, and extracting identification information about the rear vehicle; and
identifying a side vehicle using the photographed side-view image input from a side-view photographing unit, and extracting identification information about the side vehicle.

3. The method of claim 2, wherein:
the extracting of the identification information about the rear vehicle comprises identifying from the photographed rear-view image the rear vehicle for each vehicle lane, and extracting, as the identification information, a location of the rear vehicle and information about the rear vehicle, and
the extracting of the identification information about the side vehicle comprises identifying the side vehicle and extracting the identification information about the side vehicle, based on information regarding whether the identified side vehicle approaches from a left side or a right side of the vehicle.

4. The method of claim 1, wherein the extracting comprises:
extracting, as the identification information, a relative distance and a relative speed of the adjacent vehicle.

5. The method of claim 1, wherein the determining comprises:
computing an idle running distance in braking and a braking distance according to a relative speed of the adjacent vehicle;
comparing an addition of the computed idle running distance in braking and the braking distance with a relative distance of the adjacent vehicle; and
determining whether the adjacent vehicle is approaching at a speed greater than the relative speed within the relative distance when the addition is greater than the relative distance.

6. The method of claim 1, further comprising:
periodically identifying a location of the adjacent vehicle; and
displaying a driving state of the adjacent vehicle on a screen based on the location.

7. The method of claim 1, wherein the alerting comprises at least one of:
outputting an alarm sound using a sound output unit; and
vibrating a handle or a seat to alert the driver of the vehicle using a haptic unit.

8. An apparatus for alerting about a driving state of a vehicle, the apparatus comprising:
an identification unit to identify an adjacent vehicle from a photographed image;
an extraction unit to extract identification information about the adjacent vehicle;
a determination unit to determine whether the adjacent vehicle approaches based on the identification information; and
an alerting unit to alert a driver of the vehicle about a hazard due to the adjacent vehicle approaching, when the adjacent vehicle approaches.

9. The apparatus of claim 8, wherein the photographed image includes at least one of a photographed rear-view image and a photographed side-view image, and
the extraction unit extracts identification information about a rear vehicle using the photographed rear-view image input from a rear-view photographing unit, and extracts identification information about a side vehicle using the photographed side-view image input from a side-view photographing unit.

10. The apparatus of claim 9, wherein the extraction unit identifies from the rear-view photographed image the rear vehicle for each vehicle lane and extracts, as the identification information, a location of the rear vehicle and information about the rear vehicle, and the extraction unit identifies the side vehicle and extracts the identification information about the side vehicle, based on information regarding whether the identified side vehicle approaches from a left side or a right side of the vehicle.

11. The apparatus of claim 8, wherein the extraction unit extracts, as the identification information, a relative distance and a relative speed of the adjacent vehicle.

12. The apparatus of claim 8, wherein the determination unit computes an idle running distance in braking and a braking distance according to a relative speed of the adjacent vehicle, compares an addition of the computed idle running distance in braking and the braking distance with a relative distance of the adjacent vehicle, and determines the adjacent vehicle is approaching at a speed greater than the relative speed within the relative distance when the addition is greater than the relative distance.

13. The apparatus of claim 8, further comprising:
a display unit to periodically identify a location of the adjacent vehicle and display a driving state of the adjacent vehicle on a screen based on the location.

14. The apparatus of claim 8, wherein the alerting unit outputs an alarm sound using a sound output unit, or vibrates a handle or a seat to alert the driver of the vehicle using a haptic unit.
